(19) United States
(12) Patent Application Publication
(10) Pub. No.: US 2017/0037214 A1
(43) Pub. Date: Feb. 9, 2017

(54) FOAMABLE MASTERBATCH AND POLYOLEFIN RESIN COMPOSITION WITH EXCELLENT EXPANDABILITY AND DIRECT METALLIZING PROPERTY

(71) Applicants: Hyundai Motor Company, Seoul (KR); Lotte Chemical Corporation, Seoul (KR); Kia Motors Corporation, Seoul (KR)

(72) Inventors: Hak Soo KIM, Yongin-si (KR); Jung Gyun NOH, Anyang-si (KR); Dae Sik KIM, Yongin-si (KR); Kie Youn JEONG, Hwaseong-si (KR); Byung Kook NAM, Daejeon (KR); Hyung Shin LEE, Daejeon (KR)

(73) Assignees: Hyundai Motor Company, Seoul (KR); Kia Motors Corporation, Seoul (KR); Lotte Chemical Corporation, Seoul (KR)

(21) Appl. No.: 14/970,085

(22) Filed: Dec. 15, 2015

(30) Foreign Application Priority Data
Aug. 7, 2015 (KR) 10-2015-0111789

(51) Int. Cl. C08J 9/32; C08J 9/00; C08J 9/08

(52) U.S. Cl. CPC C08J 9/32; C08J 9/08; C08J 9/0061; C08J 9/0066; C08J 2205/044; C08J 2203/02; C08J 2203/22; C08J 2323/12; C08J 2423/08

(57) ABSTRACT

The present disclosure provides a masterbatch prepared by melting and extruding a mixture including a polyolefin resin, wherein the mixture includes 10 to 89% by weight of a polyolefin resin, 5 to 30% by weight of a chemical blowing agent, 5 to 30% by weight of thermally expandable microcapsule, and 1 to 30% by weight of an inorganic filler. In addition, the present disclosure provides a polyolefin resin composition with excellent expandability and direct metallizing property, which includes the foamable masterbatch. A molded article obtained by foam injection molding of the polyolefin resin composition according to one form of the present disclosure can be useful in satisfying uniform distribution and mechanical properties of foamed cells so that the molded article can be widely applied to parts for automobile interior/exterior materials, and also improving fuel efficiency of automobiles by achieving lightweight parts.

### CROSS-REFERENCE TO RELATED APPLICATIONS

This application claims the benefit of and priority to Korean Patent Application No. 10-2015-0111789, filed Aug. 7, 2015, which is incorporated herein by reference in its entirety.

### FIELD

The present disclosure relates to a foamable masterbatch for preparing lightweight parts, for example, in automobile interiors/exteriors.

### BACKGROUND

The statements in this section merely provide background information related to the present disclosure and may not constitute prior art.

Generally, plastics widely used in foamed products include polystyrene resins and polyurethane resins. The resins have been used in various fields from soft buffer materials to hard insulating materials since their expandability is easily controlled upon melting due to high melt tension. However, the polystyrene resins have a drawback in that heat resistance may not be great since they have a glass transition temperature of approximately 100° C. In addition, the polyurethane resins have a drawback in that it is difficult to secondarily mold or recycle the polyurethane resins. In particular, foamed products prepared from the plastics are restrictively used for injection-molded products in vehicles, electronic and electrical products since they have insufficient mechanical strength.

On the other hand, polypropylene resins may be widely used for injection-molded products in vehicles, electronic and electrical products since the polypropylene resins have excellent mechanical properties and heat resistance, and are secondarily moldable or recyclable. However, the polypropylene resins have drawbacks in that entrapment of gases in the resins upon foaming is impossible since melt tension of the resin is sharply lowered at a temperature exceeding a melting point thereof, and thus it is difficult to control foaming as large pores are formed by eruption of gases or bursting of foamed cells.

### SUMMARY

The present inventors have found that, when a foamable masterbatch, which is prepared by mixing a polyolefin resin, a chemical blowing agent, thermally expandable microcapsule, and an inorganic filler in predetermined amounts, is mixed with a polyolefin resin, and the resulting mixture is subjected to foam injection molding, the resulting injection-molded article has improved tensile strength, flexural modulus, impact strength, and appearance qualities while foamed cells are uniformly distributed within a size range of 50 to 400 μm, and thus it is suitable for parts for automobile interiors/exteriors. The present disclosure is presented based on these findings.

Therefore, the present disclosure provides a foamable masterbatch capable of improving foaming qualities.

The present disclosure also provides a polyolefin resin composition, which includes the foamable masterbatch, with excellent expandability and direct metallizing property.

The present disclosure further provides an injection-molded article prepared by foam injection molding the polyolefin resin composition.

In one aspect, the present disclosure provides a foamable masterbatch prepared by melting and extruding a mixture comprising a polyolefin resin. Here, the mixture includes (A) 10 to 89% by weight of a polyolefin resin, (B) 5 to 30% by weight of a chemical blowing agent, (C) 5 to 30% by weight of thermally expandable microcapsule, and (D) 1 to 30% by weight of an inorganic filler. In one aspect, the present disclosure provides a foamable masterbatch prepared by melting and extruding a mixture comprising a polyolefin resin. Here, the mixture includes (A) 10 to 89% by weight of a polyolefin resin, (B) 5 to 30% by weight of a chemical blowing agent, (C) 5 to 30% by weight of thermally expandable microcapsule, and (D) 1 to 30% by weight of an inorganic filler.

In another aspect, the present disclosure provides a polyolefin resin composition with excellent expandability and direct metallizing property, which includes 1 to 10 phr of the foamable masterbatch, based on the total weight of the polyolefin resin composition.

In still another aspect, the present disclosure provides an injection-molded article prepared by foam injection molding the polyolefin resin composition.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 are images showing cross sections of specimens prepared in Example 1(a) and Comparative Example 1(b), as viewed under an optical microscope; and

FIG. 2 are images obtained by photographing exterior surfaces of the specimens prepared in Example 1(a) and Comparative Example 1(b).

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Generally, commercially available polypropylene resins have an isotactic structure. Thus, when a chemical blowing agent is added to such polypropylene resins, and the resulting mixture is subjected to foam injection molding, appearance-related problems such as gas flow marks and swirl marks on a surface of a final injection-molded product occur due to sudden expansion of a foaming gas.

In addition, when thermally expandable microcapsules are used in the polypropylene resin, issues regarding the appearance of the final injection-molded product may be addressed, but a foaming rate may be lowered due to structural characteristics in which the a shell is surrounded by the foaming gas.

Further, since a chemical blowing agent or thermally expandable microcapsule is blended with a resin and the resulting mixture is injection-molded in a conventional foam injection process, uniform foaming may be difficult due to insufficient dispersion of the blowing agent.

Meanwhile, Korean Registered Patent No. 10-1007763 discloses a polypropylene resin composition for foam injection molding, and a foam body prepared using the same. In this case, when a propylene-based heterophase resin having a melt flow index of 3 to 50 g/10 min and a molecular weight distribution (i.e., a polydispersity index (PI)) of 7 or more is used, or has a very wide molecular weight distribution, mechanical properties of the resin composition may be degraded, and foaming and appearance qualities of the foam body may be degraded due to use of low molecular weight polypropylene.

The present disclosure is characterized in that a foamable masterbatch including a polyolefin-based resin, a chemical blowing agent, thermally expandable microcapsule, and an inorganic filler is used to improve appearance qualities of a final injection-molded product, blowing agent dispersibility, and uniformity of foaming magnitude.

Accordingly, the present disclosure provides a foamable masterbatch prepared by melting and extruding a mixture including a polyolefin resin. Here, the mixture includes (A) 10 to 89% by weight of a polyolefin resin, (B) 5 to 30% by weight of a chemical blowing agent, (C) 5 to 30% by weight of thermally expandable microcapsule, and (D) 1 to 30% by weight of an inorganic filler.

First, as a base resin used in the present disclosure, the polyolefin resin (A) that may be used herein may include at least one selected from the group consisting of a random copolymer formed by polymerization of a comonomer selected from the group consisting of homo-polypropylene (homo-PP), propylene, ethylene, butylene, and octene, a block copolymer formed by blending an ethylene-propylene rubber with polypropylene, and a copolymer of polyethylene, ethylene vinyl acetate, and α-olefin. This is because the polyolefin resin has excellent low-temperature extrudability. In particular, polyethylene is more used in one form to perform extrusion at a lower temperature.

In this case, the polyolefin resin may be used in an amount of 10 to 89% by weight, based on the total weight of the foamable masterbatch. When the content of the polyolefin resin is less than 10% by weight, processability may be degraded. On the other hand, when the content of the polyolefin resin is greater than 89% by weight, expandability may be degraded due to a decrease in content of the blowing agent. Thus, the polyolefin resin may be used within this content range.

Next, the chemical blowing agent (B) that may be used herein may include at least one selected from the group consisting of azodicarbon amide, p,p′-oxybis(benzenesulfonyl hydrazide), p-toluenesulfonyl hydrazide, benzenesulfonyl hydrazide, N,N′-dinitrosopentamethylenetetramine, p-toluenesulfonyl semicarbazide, 5-phenyltetrazol, sodium bicarbonate, zinc dibenzenesulfinate, and zinc ditoluenesulfinate.

The chemical blowing agent may be used in an amount of 5 to 30% by weight, based on the total weight of the foamable masterbatch. When the content of the chemical blowing agent is less than 5% by weight, foaming characteristics may be degraded. On the other hand, when the content of the chemical blowing agent is greater than 30% by weight, mechanical properties of a final product may deteriorate. Thus, the chemical blowing agent may be used within this content range.

The thermally expandable microcapsule (C) serves as a blowing agent, and is composed of a shell and a core. More specifically, the thermally expandable microcapsule may be composed of a shell including a polymerization product including a nitrile group-containing acrylic monomer and an amide group-containing acrylic monomer, and a core containing a volatile liquid including at least one low molecular weight hydrocarbon selected from the group consisting of ethylene, propane, propene, n-butane, isobutane, butene, isobutene, n-pentane, isopentane, neopentane, n-hexane, heptane, and petroleum ether.

The thermally expandable microcapsule may be used in an amount of 5 to 30% by weight, based on the total weight of the foamable masterbatch. When the content of the microcapsule is less than 5% by weight, issues regarding appearance of a final product may result. On the other hand, when the content of the microcapsule is greater than 30% by weight, expandability may be degraded. Thus, the thermally expandable microcapsule may be used within this content range.

In addition, the inorganic filler (D) is a component used to improve dispersibility of the blowing agent and prevent mutual interference between the other components (A, B and C). In one form, the inorganic filler (D) may include at least one selected from the group consisting of talc, calcium carbonate, calcium sulfate, magnesium oxide, calcium stearate, wollastonite, mica, silica, calcium silicate, nanoclays, whiskers, glass fibers, carbon fibers, and carbon black.

In this case, the inorganic filler may be used in an amount of 1 to 30% by weight, based on the total weight of the foamable masterbatch. When the content of the inorganic filler is less than 1% by weight, dispersibility of the blowing agent may be degraded. On the other hand, when the content of the inorganic filler is greater than 30% by weight, processability may be degraded, and the microcapsule may be damaged. Thus, the inorganic filler may be used within this content range.

Additionally, the mixture used to prepare the foamable masterbatch may further include at least one additive selected from the group consisting of an antioxidant, a UV stabilizer, a flame retardant, a coloring agent, a plasticizer, a thermal stabilizer, a slip agent, and an antistatic agent.

Further, the foamable masterbatch according to the present disclosure may be prepared by melting and extruding a mixture in which a polyolefin resin, a chemical blowing agent, thermally expandable microcapsule, and an inorganic filler are mixed in predetermined amounts.

The melting and extrusion may be performed using a single screw extruder, a twin-screw extruder, a kneader, etc. In this case, the melting and extrusion may be performed at a screw rotation speed of 50 to 300 rpm, a retention time of 5 to 90 sec, and an extrusion temperature of 180 to 200° C. Dispersibility may be degraded when the screw rotation speed is less than 50 rpm, whereas the blowing agent may deteriorate when the screw rotation speed is greater than 300 rpm. In addition, dispersibility may be degraded when the retention time is less than 5 seconds, whereas the blowing agent may deteriorate when the retention time is greater than 90 seconds. Thus, the melting and extrusion may be performed within these ranges.

Additionally, extrudability and productivity may be degraded when the extrusion temperature is less than 180° C., whereas the blowing agent may deteriorate when the extrusion temperature is greater than 200° C. Thus, the melting and extrusion may be performed within this temperature range.

In addition, the present disclosure provides a polyolefin resin composition with excellent expandability and direct metallizing property, characterized in that the polyolefin resin composition includes 1 to 10 phr of the foamable masterbatch, based on the total weight of the polyolefin resin composition.

In the case of the molded article prepared by mixing the above-described foamable masterbatch with a polyolefin resin and subjecting the resulting mixture to foam injection molding, appearance qualities, blowing agent dispersibility, and uniformity of foaming magnitude may be improved, compared to the molded article prepared by blending a chemical blowing agent or thermally expandable microcapsule with a resin and subjecting the resulting mixture to foam injection molding. These results may be confirmed through measurement of physical properties as will be described below.

Particularly, the foamable masterbatch may be included in an amount of 1 to 10 phr, based on the total weight of the polyolefin resin composition. In this case, when the content of the foamable masterbatch is less than 1 phr, expandability may be degraded. On the other hand, when the content of the foamable masterbatch is greater than 10 phr, economic feasibility and physical properties of a final product may be degraded. Thus, the foamable masterbatch may be desirably used within this content range. In this case, the polyolefin resin composition may include the polyolefin resin (A) and the inorganic filler (D) as described above, and may further include the additive.

In addition, the molded article obtained by mixing the components of the composition within content ranges and subjecting the resulting mixture to foam injection molding has foamed cells having a size of 50 to 400 μm uniformly distributed therein. When the size of the foamed cells is less than 50 μm, productivity may not be satisfactory. On the other hand, when the size of the foamed cells is greater than 400 μm, mechanical properties may not be satisfactory. Thus, the foamed cells may be formed within this size range.

Further, the injection-molded article has satisfactory mechanical properties, for example, a flexural modulus of 10,000 to 25,000 kg/cm², a tensile strength of 100 to 450 kg/cm², a heat deflection temperature of 80 to 135° C. As the injection-molded article has such satisfactory mechanical product qualities, the injection-molded article may be provided as a part for automobile interior/exterior materials.

Therefore, the polyolefin resin composition including the foamable masterbatch according to the present disclosure may have excellent foaming qualities and superior surface qualities upon foam injection molding, thereby realizing direct metallization of the molded article. In addition, the polyolefin resin composition may be applied to various fields including parts for automobile interior materials by improving mechanical properties, and also achieving lightweight parts.

Hereinafter, one or more forms of the present disclosure will be described in detail with reference to the following examples. However, these examples are not intended to limit the purpose and scope of the one or more forms of the present disclosure.

### EXAMPLES

The following examples illustrate the present disclosure and are not intended to limit the same.

### Preparation Example 1

A mixture obtained by mixing components of the masterbatch composition in content ratios as listed in the following Table 1 was injection-molded using a twin screw extruder (having a screw diameter of 30 mm, L/D 40) under conditions of a screw rotation speed of 100 rpm, a retention time of 30 seconds, and an extrusion temperature of 190° C., thereby preparing a foamable masterbatch.

### Comparative Preparation Examples 1 to 3

Foamable masterbatches were prepared in the same manner as in Preparation Example 1, except that the components of the composition and their content ratios were used as listed in the following Table 1.

TABLE 1

| | | Prep- | Comparative Preparation | | | |
|---|---|---|---|---|---|---|
| | | aration | Example | | | |
| Items | | Example 1 | 1 | 2 | 3 | 4 |
| Masterbatch | Polypropylene¹⁾ | 55 | 50 | 50 | 72 | 72 |
| composition | Chemical blowing | 20 | 5 | 40 | 3 | 20 |
| | agent²⁾ | | | | | |
| | Thermally | 20 | 40 | 5 | 20 | 3 |
| | expandable | | | | | |
| | microcapsule³⁾ | | | | | |
| | Inorganic filler⁴⁾ | 5 | 5 | 5 | 5 | 5 |

| | | | | | |
|---|---|---|---|---|---|
| Total (units: % by weight) | 100 | 100 | 100 | 100 | 100 |

¹⁾JM-370 (PP, Lotte Chemical Corp.)
²⁾H3510 (Sodium bicarbonate, EIWA)
³⁾EM-403 (Thermally expandable microcapsule, SEKISUI)
⁴⁾KC-400 (d₅₀ 8 μm talc, Koch Co., Ltd.)

### Examples 1 to 4

While the polyolefin resin compositions listed in Table 2 were subjected to foam injection molding under conditions of a screw rotation speed of 300 rpm, a retention time of 20 seconds, and an extrusion temperature of 180° C. using the twin screw extruder, the foamable masterbatch of Preparation Example 1 was added thereto to prepare specimens.

### Comparative Example 1 to 10

Specimens having the same size were prepared in the same manner as in Examples 1 to 4, except that the components of the composition and their content ratios were used as listed in the following Table 2. However, the foamable masterbatches prepared in Comparative Preparation Examples 1 to 4 were used as the foamable masterbatches used in Comparative Examples 7 to 10. Specifically, the foamable masterbatch of Comparative Preparation Example 1 was used as the foamable masterbatch of Comparative Example 7, the foamable masterbatch of Comparative Preparation Example 2 was used as the foamable masterbatch of Comparative Example 8, the foamable masterbatch of Comparative Preparation Example 3 was used as the foamable masterbatch of Comparative Example 9, and the foamable masterbatch of Comparative Preparation Example 4 was used as the foamable masterbatch of Comparative Example 10.

The compositions of Examples 1 to 4 and Comparative Examples 1 to 10, and the component content ratios are listed in the following Tables 2 and 3.

TABLE 2

| | | | Examples | | | |
|---|---|---|---|---|---|---|
| Items | | | 1 | 2 | 3 | 4 |
| Polyolefin | Polypropylene¹⁾ | % by | 80 | 80 | 70 | 70 |
| resin | | weight | | | | |
| composition | Rubber²⁾ | % by | 10 | 10 | 15 | 15 |
| | | weight | | | | |
| | Inorganic filler³⁾ | % by | 10 | 10 | 15 | 15 |
| | | weight | | | | |
| | Total | % by | 100 | 100 | 100 | 100 |
| | | weight | | | | |
| Blowing | Chemical | phr | — | — | — | — |
| agent | blowing agent⁴⁾ | | | | | |
| | Thermally | phr | — | — | — | — |
| | expandable | | | | | |
| | microcapsule⁵⁾ | | | | | |
| | Foamable | phr | 2.5 | 5 | 2.5 | 5 |
| | masterbatch⁶⁾ | | | | | |

¹⁾JM-370 (PP, Lotte Chemical Corp.)
²⁾EG-8842 (EOR, DOW)
³⁾KC-400 (d₅₀ 8 μm talc, Koch Co., Ltd.)
⁴⁾H3510 (Sodium bicarbonate, EIWA)
⁵⁾EM-403 (Thermally expandable microcapsule, SEKISUI).
⁶⁾Foamable masterbatch: 55% by weight of low density polyethylene (LDPE), 20% by weight of sodium bicarbonate, 20% by weight of EM-403, and 5% by weight of talc

TABLE 3

| | | | Comparative Examples | | | | | | | | | |
|---|---|---|---|---|---|---|---|---|---|---|---|---|
| Items | | | 1 | 2 | 3 | 4 | 5 | 6 | 7 | 8 | 9 | 10 |
| Polyolefin | Polypropylene¹⁾ | % by | 80 | 80 | 80 | 80 | 70 | 70 | 70 | 70 | 70 | 70 |
| resin | | weight | | | | | | | | | | |
| composition | Rubber²⁾ | % by | 10 | 10 | 10 | 10 | 15 | 15 | 15 | 15 | 15 | 15 |
| | | weight | | | | | | | | | | |
| | Inorganic | % by | 10 | 10 | 10 | 10 | 15 | 15 | 15 | 15 | 15 | 15 |
| | filler³⁾ | weight | | | | | | | | | | |
| | Total | % by | 100 | 100 | 100 | 100 | 100 | 100 | 100 | 100 | 100 | 100 |
| | | weight | | | | | | | | | | |
| Blowing | Chemical | phr | 1 | 2 | — | — | 2 | — | — | — | — | — |
| agent | blowing | | | | | | | | | | | |
| | agent⁴⁾ | | | | | | | | | | | |
| | Thermally | phr | — | — | 1 | 2 | — | 2 | — | — | — | — |
| | expandable | | | | | | | | | | | |
| | microcapsule⁵⁾ | | | | | | | | | | | |
| | Foamable | phr | — | — | — | — | — | — | 5 | 5 | 5 | 5 |
| | masterbatch⁶⁾ | | | | | | | | | | | |
| | of | | | | | | | | | | | |
| | Comparative | | | | | | | | | | | |
| | Preparation | | | | | | | | | | | |
| | Example | | | | | | | | | | | |

¹⁾JM-370 (PP, Lotte Chemical Corp.)
²⁾EG-8842 (EOR, DOW)
³⁾KC-400 (d₅₀ 8 μm talc, Koch Co., Ltd.)
⁴⁾H3510 (Sodium bicarbonate, EIWA)
⁵⁾EM-403 (Thermally expandable microcapsule, SEKISUI)

### TEST EXAMPLES

### Test Example

### Measurement of Physical Properties

The specimens prepared in Examples 1 to 4 and Comparative Examples 1 to 10 were measured to determine physical properties thereof using measurement methods as follows. Results are listed in the following Tables 4 and 5.

1) Tensile (yield) strength was measured according to an evaluation method specified in ASTM D638.

2) Flexural modulus was measured according to an evaluation method specified in ASTM D790.

3) Izod impact strength was measured according to an evaluation method specified in ASTM D256.

4) Appearance qualities were evaluated by calculating an average value of evaluations carried out by five quality raters.

5) An average diameter of foamed cells with a size of 1×1 cm was measured using an optical microscope.

TABLE 4

| Items | | | Example 1 | Example 2 | Example 3 | Example 4 |
|---|---|---|---|---|---|---|
| Physical | Tensile (yield) | Kg/cm² | 205 | 225 | 230 | 265 |
| properties | strength | | | | | |
| | Flexural | Kg/cm² | 22,500 | 23,600 | 23,400 | 24,600 |
| | modulus | | | | | |
| | Izod impact | kg · cm/cm | 20 | 22 | 25 | 27 |
| | strength (at | | | | | |
| | 23° C.) | | | | | |
| | Appearance | ° C. | Very | Good | Very | Good |
| | qualities | | good | | good | |
| | Average | μm | 141 | 135 | 130 | 122 |
| | diameter of | | | | | |
| | foamed cells | | | | | |

TABLE 5

| | | | Comparative Example | | | | | | | | | |
|---|---|---|---|---|---|---|---|---|---|---|---|---|
| Items | | | 1 | 2 | 3 | 4 | 5 | 6 | 7 | 8 | 9 | 10 |
| Physical | Tensile | kg/cm² | 185 | 175 | 175 | 165 | 175 | 185 | 160 | 165 | 165 | 170 |
| properties | (yield) | | | | | | | | | | | |
| | strength | | | | | | | | | | | |
| | flexural | kg/cm² | 20,400 | 20,000 | 19,600 | 18,100 | 22,600 | 22,100 | 17,500 | 18,000 | 18,500 | 18,500 |
| | modulus | | | | | | | | | | | |
| | Izod impact | kg. | 10 | 8 | 8 | 5 | 6 | 5 | 7 | 4 | 12 | 12 |
| | strength | cm/cm | | | | | | | | | | |
| | (at 23° C.) | | | | | | | | | | | |
| | Appearance | ° C. | Bad | Very | Bad | Very | Very | Very | Good | Very | Good | Good |
| | qualities | | | bad | | bad | bad | bad | | bad | | |
| | Foamed cells | μm | 420 | 415 | 480 | 473 | 400 | 468 | 400 | 350 | 600 | 650 |
| | average | | | | | | | | | | | |
| | diameter | | | | | | | | | | | |

As listed in Tables 4 and 5, it could be seen that the specimens of Examples 1 to 4 in which the foamable masterbatch was used in the polyolefin resin composition had excellent mechanical properties such as tensile strength, flexural modulus, impact strength, excellent appearance qualities, and foamed cell uniformity, compared to the specimens of Comparative Examples 1 to 6 in which the chemical blowing agent or the thermally expandable microcapsule was used alone.

In addition, it could be seen that the mechanical properties and foaming characteristics were improved as the contents of the filler and the rubber in the polyolefin resin were increased. Additionally, it could be seen that the physical properties and appearance qualities were degraded in the case of Comparative Examples 7 to 10, indicating that the ratio of the blowing agent was not proper.

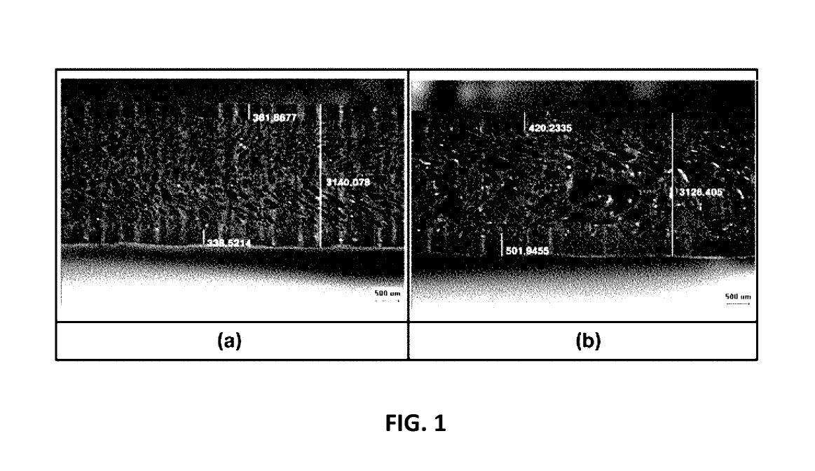

Additionally, FIG. 1 is an image showing cross sections of the specimens prepared in Example 1 and Comparative Example 1, as viewed under an optical microscope. As shown in FIG. 1, it was revealed that the foamed cells were uniformly formed in the specimens of Example 1 of the present disclosure.

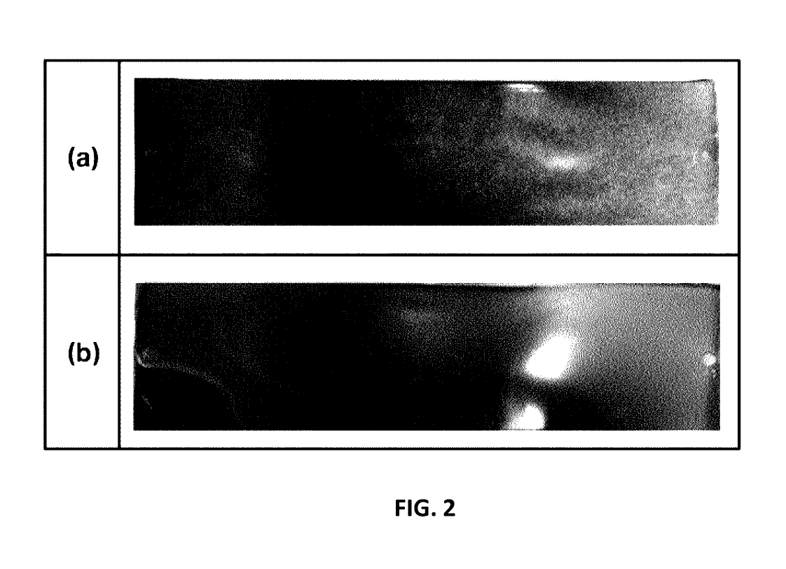

Further, FIG. 2 is an image obtained by photographing appearances of the specimens prepared in Example 1 and Comparative Example 1. As shown in FIG. 2, it was revealed that the specimens of Example 1 of the present disclosure had excellent appearance qualities since gas flow marks, and swirl marks were reduced when viewed with the naked eye.

Therefore, the polyolefin resin composition including the foamable masterbatch according to the present disclosure had satisfactory mechanical properties such as tensile strength, flexural modulus, and impact strength, and improved appearance qualities while foamed cells were uniformly distributed and formed within a size range of 50 to 400 μm. Thus, the polyolefin resin composition was more suitable for parts for automobile interior/exterior materials.

As described above, the foamable masterbatch according to one form of the present disclosure can improve foaming qualities of the polyolefin resin, and thus has excellent mechanical properties such as tensile strength, flexural modulus, and impact strength while the foamed cells are uniformly distributed within a size range of 50 to 400 μm upon foam injection molding. In addition, the foamable masterbatch has improved appearance qualities, and thus is more suitable for parts for automobile interior/exterior materials.

Further, the molded article obtained by subjecting the polypropylene resin composition according to one form of the present disclosure to foam injection molding can be applied to parts for automobile interior/exterior materials. Therefore, the molded article can be useful in satisfying uniform distribution and mechanical properties of the foamed cells, and also improving fuel efficiency of automobiles by achieving lightweight parts.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A foamable masterbatch prepared by melting and extruding a mixture comprising a polyolefin resin,
wherein the mixture comprises:
(A) 10 to 89% by weight of a polyolefin resin;
(B) 5 to 30% by weight of a chemical blowing agent;
(C) 5 to 30% by weight of thermally expandable microcapsule; and
(D) 1 to 30% by weight of an inorganic filler.

2. The foamable masterbatch of claim 1, wherein the polyolefin resin (A) comprises at least one selected from the group consisting of a random copolymer formed by polymerization of a comonomer selected from the group consisting of homo-polypropylene (Homo-PP), propylene, ethylene, butylene, and octene, a block copolymer formed by blending an ethylene-propylene rubber with polypropylene, and a copolymer of polyethylene, ethylene vinyl acetate, and α-olefin.

3. The foamable masterbatch of claim 1, wherein the chemical blowing agent (B) comprises at least one selected from the group consisting of azodicarbon amide, p,p′-oxybis(benzenesulfonyl hydrazide), p-toluenesulfonyl hydrazide, benzenesulfonyl hydrazide, N,N′-dinitrosopentamethylenetetramine, p-toluenesulfonyl semicarbazide, 5-phenyltetrazol, sodium bicarbonate, zinc dibenzenesulfinate, and zinc ditoluenesulfinate.

4. The foamable masterbatch of claim 1, wherein the thermally expandable microcapsule (C) is composed of a shell comprising a polymerization product including a nitrile group-containing acrylic monomer and an amide group-containing acrylic monomer; and a core containing a volatile liquid comprising at least one low molecular weight hydrocarbon selected from the group consisting of ethylene, propane, propene, n-butane, isobutane, butene, isobutene, n-pentane, isopentane, neopentane, n-hexane, heptane, and petroleum ether.

5. The foamable masterbatch of claim 4, wherein the inorganic filler (D) comprises at least one selected from the group consisting of talc, calcium carbonate, calcium sulfate, magnesium oxide, calcium stearate, wollastonite, mica, silica, calcium silicate, nanoclays, whiskers, glass fibers, carbon fibers, and carbon black.

6. The foamable masterbatch of claim 1, further comprising at least one selected from the group consisting of an antioxidant, a UV stabilizer, a flame retardant, a coloring agent, a plasticizer, a thermal stabilizer, a slip agent, and an antistatic agent.

7. A polyolefin resin composition with excellent expandability and direct metallizing property, comprising 1 to 10 phr of the foamable masterbatch defined in claim 1, based on the total weight of the polyolefin resin composition.

8. An injection-molded article prepared by foam injection molding the polyolefin resin composition defined in claim 7.

9. The injection-molded article of claim 8, wherein the injection-molded article has a flexural modulus of 10,000 to 25,000 kg/cm², a tensile strength of 100 to 450 kg/cm², and a heat deflection temperature of 80 to 135° C.

10. The injection-molded article of claim 8, wherein the injection-molded article is a part for automobile interior/exterior materials.

11. The injection-molded article of claim 7, wherein the injection-molded article has foamed cells having a size of 50 to 400 μm.
